(19) United States
(12) Patent Application Publication
(10) Pub. No.: US 2026/0187439 A1
(43) Pub. Date: Jul. 2, 2026

(54) EFFICIENT FLOATING-POINT SRAM COMPUTE-IN-MEMORY BY HARNESSING MANTISSA ADDITION

(71) Applicant: The George Washington University, Washington, DC (US)

(72) Inventors: Weidong CAO, Columbia, MD (US); Yiwen LIANG, Arlington, VA (US)

(21) Appl. No.: 19/070,970

(22) Filed: Mar. 5, 2025

Related U.S. Application Data
(60) Provisional application No. 63/562,339, filed on Mar. 7, 2024.

(51) Int. Cl. G06N 3/065

(52) U.S. Cl. CPC G06N 3/065

(57) ABSTRACT

The compute-in-memory (CIM) paradigm holds great promise to efficiently accelerate machine learning workloads. Among memory devices, static random-access memory (SRAM) stands out as a practical choice due to its exceptional reliability in the digital domain and balanced performance. Recently, there has been a growing interest in accelerating floating-point (FP) deep neural networks (DNNs) with SRAM CIM due to their critical importance in DNN training and high-accurate inference. However, most prior efforts in SRAM CIM have been devoted to quantized deep neural networks (DNNs), leaving the acceleration of floating-point (FP) DNNs largely underexplored, despite their critical importance. An efficient SRAM CIM macro for FP DNNs. To achieve the design, we identify a lightweight approach that decomposes conventional FP mantissa multiplication into two parts: mantissa sub-addition (sub-ADD) and mantissa sub-multiplication (sub-MUL). Our study shows that while mantissa sub-MUL is compute-intensive, it only contributes to the minority of FP products, whereas mantissa sub-ADD, although compute-light, accounts for the majority of FP products. Recognizing “Addition is Most You Need”, we develop a hybrid-domain SRAM CIM macro to accurately handle mantissa sub-ADD in the digital domain while improving the energy efficiency of mantissa sub-MUL using analog computing. Experiments with the MLPerf benchmark demonstrate its remarkable improvement in energy efficiency by 8.7×˜9.3× (7.3×˜8.2×) in inference (training) compared to a fully digital FP baseline without any accuracy loss, showcasing its great potential for FP DNN acceleration.

### RELATED APPLICATIONS

This claims the benefit of priority of U.S. Application No. 63/562,339, filed Mar. 7, 2024, the content of which is relied upon and incorporated herein by reference in its entirety. The references cited in the provisional application are hereby incorporated by reference in their entireties herein.

### BACKGROUND

Previous work has explored Compute-In-Memory (CIM) acceleration for Floating Point (FP) Deep Neural Network (DNN) models with emerging Non-Volatile Memory (NVM) devices. Despite their great promise compared to graphic processing units and systolic neural processing units, such NVM devices are still in the early stages of development and are not reliable enough for practical applications. Recently, Static Random-Access Memory (SRAM) has emerged as the cornerstone in the design of CIM systems for practical applications because of its exceptional accuracy in digital computing, coupled with superior performance, power efficiency, and area.

However, exploration of SRAM CIM macros has been limited to a few prototypes for edge/cloud applications. As an example, the prior work proposes a reconfigurable Floating Point/Integer (FP/INT) CIM processor to enable flexible support of BFloat16 (BF16)/FP32 and INT8/16 in the same digital CIM macro. Another work divides FP operations into high-efficiency intensive-CIM and flexible sparse-digital parts, as it observes that most exponents of FP data are clustered in a small range. Circuit-level techniques, such as the time-domain exponent summation mechanism, are also used to improve the energy efficiency of CIM macros. Despite these different implementations, they primarily focus on accurately accelerating almost every exponent summation and mantissa multiplication in the digital domain, resulting in remarkable, yet unnecessary energy waste.

### SUMMARY

A CIM system is provided that utilizes efficient SRAM CIM macros for FP DNNs. that the system decomposes conventional FP mantissa multiplication into two parts: mantissa sub-addition (sub-ADD) and mantissa sub-multiplication (sub-MUL). A general FP number in scientific notation is expressed as f=(−1)\hat{ }S·2\hat{ }E·1·M. Here, S (S=0 or S=1), E, and M (M∈(0, 1)) represent the sign, exponent, and mantissa (fraction) of the number, respectively. As an example, the conventional FP mantissa multiplication of two positive numbers is shown as 1.M_0*1.M_1=(1+M_0)*(1+M_0)=(1+M_0+M_1+M_0*M_1). Here, (1+M_0+M_1 is defined as sub-ADD and M_0*M_1 is defined as sub-MUL.

While mantissa sub-MUL is compute-intensive, it only contributes to the minority of FP products, whereas mantissa sub-ADD, although compute-light, accounts for the majority of FP products. A hybrid-domain SRAM CIM macro is utilized to accurately handle mantissa sub-ADD in the digital domain while improving the energy efficiency of mantissa sub-MUL using analog computing. Experiments with the MLPerf benchmark demonstrate its remarkable improvement in energy efficiency by 8.7×˜ 9.3×(7.3×˜8.2×) in inference (training) compared to a fully digital FP baseline without any accuracy loss, showcasing its great potential for FP DNN acceleration.

### BRIEF DESCRIPTION OF THE FIGURES

FIG. 1(a) is a block diagram showing structure overview of the CIM system having an FP SRAM CIM macro.

FIG. 1(b) is a flow diagram.

FIG. 1(c) is a chart that illustrates the exponent difference extraction in the time domain.

FIG. 1(d) is a chart that illustrates mantissa shift based on the exponent difference (using FP16 as an example).

FIG. 2 is a sub-circuit design of HD-MVA, showing) structure of HD-MVA, elementary circuits used in local computing cells, such as the analog MUL unit and the digital AND and OR gate, and local computing cell to implement the hybrid computing mechanism.

### DETAILED DESCRIPTION

In describing the present disclosure illustrated in the drawings, specific terminology is resorted to for the sake of clarity. However, the present disclosure is not intended to be limited to the specific terms so selected, and it is to be understood that each specific term includes all technical equivalents that operate in a similar manner to accomplish a similar purpose.

By carefully examining FP arithmetic, we find a lightweight manner to allow a hardware-friendly implementation of SRAM CIM macros with enhanced energy efficiency while maintaining the accuracy of FP DNNs. To show the key idea, we decomposed the conventional FP mantissa multiplication into two parts as (1.M₀· 1.M₁)=(1+M₀)·(1+M₁)=(1+M₀+M₁+M₀·M₁), where (1+M₀+M₁) is defined as mantissa sub-addition (sub-ADD) and (M₀·M₁) is defined as mantissa sub-multiplication (sub-MUL). Following the decomposition and given M₀₍₁₎ ∈(0, 1), we study the significance of sub-MUL in mantissa multiplication, i.e.,

$$\frac{{M}_{0} \cdot {M}_{1}}{〈 1 + {M}_{0} ) \cdot ( 1 + {M}_{1} )} = \frac{1}{( 1 + 1 / {M}_{0} ) \cdot ( 1 + 1 / {M}_{1} )} \leq \frac{1}{4} . \qquad ( 1 )$$

Here, the ‘=’ holds true if and only if M₀=M₁→1. Equation (1) shows that for a single weight-activation pair, if the computation accuracy of sub-ADD can be ensured, the total computation error of mantissa multiplication (also for the FP product) does not exceed ¼ compared to its ground truth even by aggressively removing the sub-MUL.

The analysis here shows that although mantissa sub-MUL operations are computationally intensive, they often impact a minority of FP products. In contrast, mantissa sub-ADD, though computationally lighter, often constitutes the majority of FP products. And addition is much more energy efficient compared to multiplication. For example, INT8 addition consumes about 10% energy of INT8 multiplication.

Accordingly, the system uses a FP SRAM CIM macro-design strategy that accounts for this distinction between mantissa sub-ADD and mantissa sub-MUL. For example, in some embodiments, the system allocates digital resources to ensure the precision of compute-light mantissa sub-ADD and employs energy-efficient analog computing for compute-intensive mantissa sub-MUL.

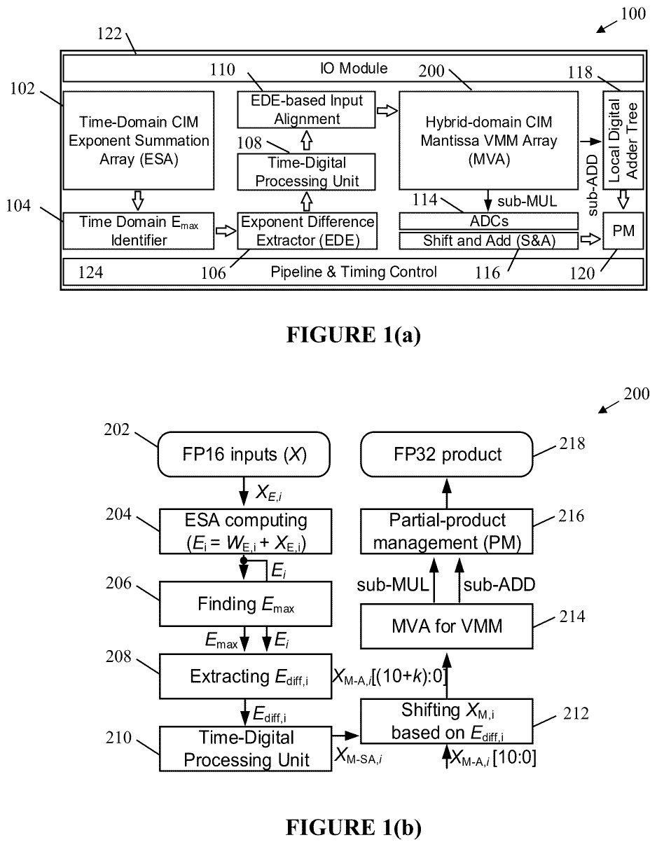

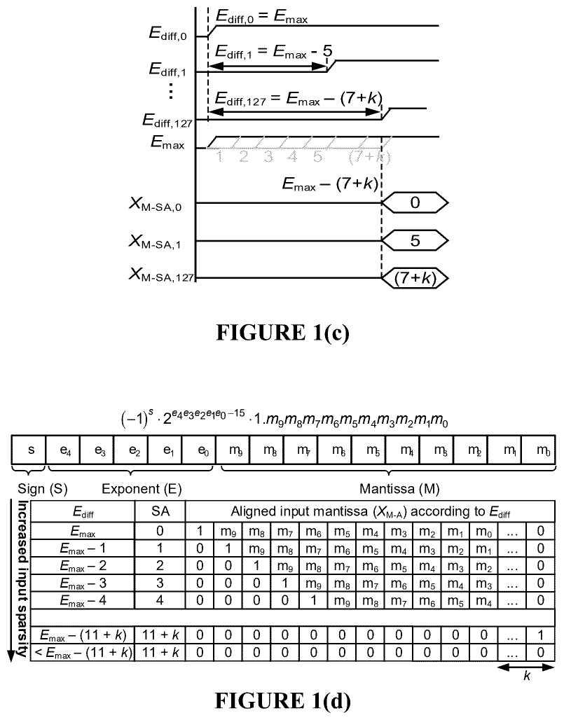

Hybrid-Domain FP SRAM CIM Macro System 100 (FIG. 1(a))

FIG. 1(a) illustrates the microarchitecture of the SRAM CIM macro system 100 that implements a SRAM CIM macro (e.g., targeting FP16 DNN models) in accordance with a non-limiting illustrative embodiment of the present disclosure. The SRAM CIM macro system 100 includes a time-domain CIM Exponent Summation Array 102 (ESA, to add the exponent parts of weight-activation pairs), time-domain MAX identifier 104 (to find the maximum exponent sum), Exponent Difference Extractor 106 (EDE, to extract the exponent difference between each exponent sum and the maximum one), time-to-digital processing unit 108 (to convert the exponent difference in the time domain into digits), EDE-based input alignment unit 110 (to shift mantissa parts of activations), hybrid-domain CIM mantissa VMM array 200 (HD-MVA, for FP Vector-Matrix Multiplication (VMM), analog-to-digital converters (ADCs) 114, shift-and-add (S&A) module 116, local digital adder tree 118, partial-product management (PM) unit 120, and other auxiliary modules such as the IO module 122 and pipeline and timing control unit 124.

Components 102-120 are essential peripheral circuits (i.e., processors) for the FP CIM macro. They are used to achieve a particular function. Thus, any suitable circuit architecture and implementations can be utilized. In FIG. 1(a), the time domain identifier 104, and the ADCs 114 are analog circuits, and components elements 106, 108, 110, 116, 118, 120, 122, 124 are digital circuits. The ESA 102 and the MVA 200 are SRAM arrays. Components 104, 106, 110, 120 are all processing units of one or more processors. All of the components 102-120 are connected to and in electronic communication with at least the adjacent one, and the ESA 102 and ADCs 114 are connected to the IO Module 122, and all others are connected to the control 124.

The CIM system 100 implements exponent summation and alignment in the time domain, which is energy efficient as compared to other digital implementation manners, though other digital implementations can be utilized. For mantissa multiplication, a hybrid-domain SRAM CIM macro precisely manages mantissa sub-ADD in the digital realm while enhancing the energy efficiency of mantissa sub-MUL through analog computing.

Operation 200 (FIG. 1(b))

Turning to FIG. 1(b), the computation process 200 of the SRAM CIM Macro system 100 is shown. The process 200 starts with FP16 inputs (X), Step 202. The FP16 inputs (X) are from the IO 122. The IO receives the inputs X from off-chip memory module, i.e., provided by external components. In other words, the FP CIM macro, when working as a processor, receives external inputs for processing.

At Step 204, the ESA 102 receives X_{E,i} from the inputs 202, and computes the sum of the exponent parts of each weight-activation pair in the time domain i.e., Eᵢ=W_{E,i}+X_{E,i}. The weight-activation pair means a pair of weight W and input X. Weights W are pre-stored in the SRAM macro. Specifically, the exponent part of W, i.e., W_{E,i.}, is stored in the ESA 102, and the mantissa part of W, i.e., W_{M,i} is stored in 200. The purpose of computing the sum is to prepare for the mantissa shift of the input in Step 212. The exponent part must first be executed to follow the standard FP arithmetic operation principles. The reason to perform exponent summation on multiple weight-activation pairs is due to the essential property of neural network, where each kernel has multiple weights. The ESA 102 is a sub-processor to perform exponent summation. The output of step 204 is the sum, Eᵢ of the exponent part of all weigh-activation pairs.

In Step 206, the time-domain MAX identifier 104 receives Eᵢ from the ESA 102 and determines the maximum exponent sum, Eₘₐₓ, among all sums. Emax is the maximum value of all Eᵢ. It is used to obtain the exponent difference between Emax and each Eⱼ. Based on this difference, the mantissa shift of input in step 212 can be achieved. All these steps can utilize any suitable standard FP arithmetic operations. In step 206, the maximum value of all Eᵢ, Eₘₐₓ, is obtained.

In Step 208, the EDE unit 106 receives all exponent sums (Eᵢ, i=0, . . . , n−1) (generated by the ESA 102) and Eₘₐₓ from the time-domain MAX identifier 104. The EDE unit 106 obtains the exponent difference E_{diff,i} between each exponent sum E; and the maximum exponent sum Emax, i.e., E_{diff,i}=Eₘₐₓ−Eᵢ. Eₘₐₓ is the maximum value of all Eᵢ. It is used to obtain the exponent difference between Emax and each Eᵢ. Based on this difference, the mantissa shift of input in 212 can be achieved. All these steps follow the standard FP arithmetic operations. In step 206, the maximum value of all Eᵢ. Eₘₐₓ, is obtained. Ei shown with a separate connection to step 208. It is used to obtain the exponent difference, E_{diff,i}, between Eₘₐₓ and each Eᵢ.

In particular, Ed is calculated by measuring the time interval between the rising edges of Eᵢ and Eₘₐₓ as shown in FIG. 1(c). Ei shown with a separate connection to 208 not 206. It is used to obtain the exponent difference, E_{diff},i, between Eₘₐₓ and each Eᵢ. It is shown by the timing diagram Ediff,0, Ediff,1, . . . , in FIG. 1c. It is the exponent difference, E_{diff},i, between Eₘₐₓ and each Eᵢ.

In Step 210, the time-to-digital processing unit 108 receives the exponent difference E_{diff,i} from the EDE unit 106. The time-to-digital processing unit 108 converts the E_{diff,i} from the time domain into a digital shift-amount (SA) value, X_{M-SA,i}, for each mantissa, X_{M,i}. The conversion relation between E_{diff,i} and X_{M-SA,i} is illustrated, for example, in FIG. 1(c). In FIG. 1(d), the difference is directly translated to padding “0”s at the left side of input mantissa shown in FIG. 1(d). It is done by the Time-Digital Processing Unit 108 by padding “0”s to the left side of input mantissa.

At step 212, the EDE-based input alignment 110 receives the XM-SA,i from the time-digital processing unit 108. With this X_{M-SA,i}, in step 212, the EDE-based input alignment 110 shifts the original mantissa X_{M,i} to generate the aligned mantissa, X_{M-A,i} with the same bit-width, i.e., 11+k. This shift can utilize any suitable standard FP arithmetic operations. The alignment 110 is implemented by a processor. Activations have the same meaning as “inputs”. In neural networks, the inputs to the subsequent intermediate layers are often called “activations”.

If E_{diff,i}> (10+k), X_{M-A,i} would become 0, allowing computation to be skipped, where 10 is the bit width of the mantissa part in FP16 format (1 hidden bit plus 10 explicit mantissa bits). Note that k is a tuning value, allowing for a further trade-off between accuracy and energy efficiency, which is discussed in the next paragraph. Otherwise, if E_{diff,i}> (10+k), X_{M-A,i}, as shown in FIG. 1(d), the insert-0 behavior coupled with the growth of the exponent difference increases the bit-level sparsity, which reduces the energy consumption of the HD-MVA with the input-sparsity-aware circuit. XM-A,i[10:0] is the original mantissa of input. XM-A,I is the shift amount that is applied to XM-A,i[10:0]. The output of 212 XM-A,i[10+k:0] is the shifted/mantissa.

In step 214, the MVA 200 receives the aligned mantissa parts from the EDE-based input alignment 110. The MVA 200 uses the aligned mantissa parts to achieve VMM with analog computing, sub-MUL, and digital computing, sub-ADD. The VMM is the “aligned mantissa parts” the XM-A,i[(10+k):0] of FIG. 1(b). The vector-matrix multiplication (VMM) is obtained due to the parallel computation property of memory array enabled by 200.

The MVA 200 then transmits the sub-MUL to the ADCs 114, and transmits the sub-ADD to the Local Digital Adder Tree 118. As noted, the ADC(s) 114 converts the results from sub-MUL into digital forms, which are shifted and accumulated by the S&A unit 116. The results of sub-ADD are further processed by the adder tree 118 for reduction.

The ADC(s) 114 convert the results from sub-MUL into digital forms, which are shifted and accumulated by the S&A unit 116. The results of sub-ADD are further processed by the adder tree 118 for reduction.

Finally, at Step 216, the PM 120 receives from the S&A 116, and also receives the sub-ADD from the Adder Tree 118. The MVA 200 sends the result of sub-ADD of each weight-activation pair. The Adder Tree 118 accumulates these results across all pairs.

The PM Unit 120 post-processes the Emax (from the Time Domain Identifier 104), the partial products from sub-MUL and the sub-ADD to obtain the final product in the standard FP32 format.

Ideally, the bit-width of an aligned activation mantissa is (11+Eₘₐₓ−Eₘᵢₙ), where Eₘᵢₙ is the minimum exponent sum among all Eᵢ. However, if (Eₘₐₓ−Eₘᵢₙ) is too large, the product of a weight-activation pair whose exponent sum is in the neighbors of Eₘᵢₙ could have a negligible contribution to the final product of the VMM. Therefore, we use the tunable k to find a proper shift-amount value for alignment, which can ensure the accuracy of the computation while further improving the energy efficiency. Additionally, we use a coarse pipeline to increase the throughput of the CIM macro, where Steps 204 to 210 are classified into pipeline stage one and the remaining steps 212-216 are in pipeline stage two. The two stages are utilized because the execution of exponent part and mantissa part cannot be simultaneous. They must be separate.

Sub-circuit design: Any suitable circuit blocks can be used to implement steps 204 to 212.

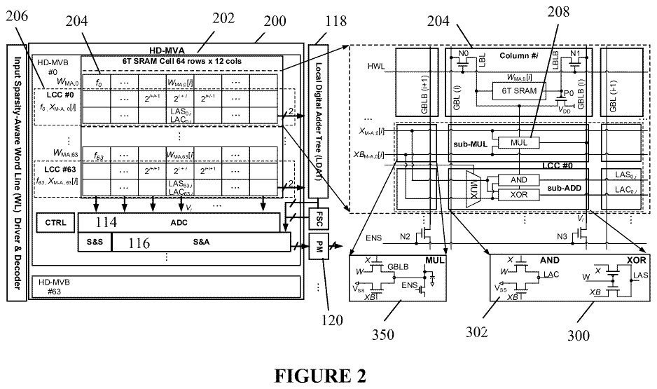

FIG. 2 shows detail of the HD-MVA 200 in accordance with an illustrative, non-limiting example of the disclosure. The HD-MVA contains 64 hybrid-domain CIM mantissa VMM banks (HD-MVB) 202. Each HD-MVB bank 202 is used for computing the product of aligned activation mantissa X_{M-A} and weight mantissa W_{MA}, i.e., Σ(X_{M-A,i}·W_{MA,i}). Here, X_{M-A,i} is (11+k)−b wide; W_{MA,i} is 12-b wide and represented in 2's complement.

To show the working mechanism of HD-MVB, we assume k=0 for simplicity and take the circuit 300 as an example. Each HD-MVB 200 comprises a 6T-SRAM cell array 204 (64 rows and 12 columns) and a local computing cell (LCC) 206 associated with each row. In particular, each bit of W_{MA,i} is stored in the same row but across different columns of the 6T-SRAM cell array in the order from the most significant bit (MSB) to the least significant bit (LSB). Each LCC 206 includes a one-bit multiplication unit (MUL) 208 for sub-MUL in the analog domain and a half adder 302 for sub-ADD in the digital domain.

In each input cycle j, the row i sends a 2-b sum of (X_{M-A,i}[j]+W_{MA,i}[j]), i.e., LAS_{i,j} and LAC_{i,j}, to the local digital adder tree (LDAT). Here, LAS_{i,j} is the local-add sum bit, and LAC_{i,j} is the local-add carry bit. In the same cycle, each column (global bitline bar, GBLB) also generates a partial product of X_{M-A,i}[j] and WMA. Across cycles, the LDAT 118 accumulates partial sums of mantissa summation and the S&A logic 116 accumulates the partial products of mantissa multiplication. Finally, the PM unit 120 combines these results to generate the standard FP32 product for subsequent processing. The two pass-transistors (N0/N1) connect GLB/GBLB to the local bitline (LBL/LBLB) for read and write operations in SRAM mode.

In standby mode, the horizontal wordline (HWL) is activated, i.e., HWL=1, with GBLs pre-charging LBLs. The selected WL is activated to read 1b of weight mantissa (e.g., W_{MA}[j]), which is stored in the SRAM cell accessed with a large voltage swing. The multiplexer (MUX) is used to select a specific bit of X_{M-A} to be added to the corresponding bit of the weight mantissa in a cycle, whose control signal is from the decoder in the input module of the HD-MVA. The schematics of the MUL unit 350 for sub-MUL operation and the AND/OR gate for sub-ADD operation 300 are illustrated in FIG. 2. All of these circuits leverage a two-transistor structure for minimizing area overhead.

Accordingly, the system 100 provides lower energy efficiency of current FP compute in memory macro. We identify a lightweight mechanism to accelerate FP DNNs by decomposing FP mantissa multiplication into two parts: accuracy-oriented mantissa sub-ADD and efficiency-oriented mantissa sub-MUL. We tailor a hybrid-domain SRAM CIM macro to implement the mechanism by placing mantissa sub-ADD in the digital domain and performing mantissa sub-MUL in the analog domain. Detailed circuit- and microarchitecture-level features of the FP SRAM CIM macro, such as local computing cells and computation flow, are elaborated.

By decomposing mantissa multiplication into two parts, i.e., mantissa sub-addition (sub-ADD) and mantissa sub-multiplication (sub-MUL), we find that sub-ADD contributes to ˜75% of FP products while consuming <10% of the total energy. The system 100 is unique in that insights of decompose FP mantissa to accelerate high energy efficiency computation. The circuits design for Mantissa multiplication and accumulation.

It is noted that in the embodiment shown, an SRAM is used. However, any suitable memory can be utilized within the spirit and scope of the disclosure, including for example a Random Access Memory (RAM).

In the embodiments shown and described, the Time-Digital Processing Unit 4, PM unit 120, and timing control unit 124 can include a processing device to perform various functions and operations in accordance with the disclosure. In particular, the control unit 124 can be a controller or the like that coordinates every computing component disclosed and orchestrate the dataflow in a balanced pipeline. For example, the controller 124 can provide a control unit weight output, a first digital control unit activation output (X_{M-A,0[i]}), and a second digital control unit activation output (XB_{M-A,0[i]}). A random-access memory device (RAM) receives the control unit weight output (HWL), and retrieves a stored memory value in response to a memory weight input. The stored memory value forms the RAM memory device output. An analog circuit receives the first and second digital control unit activation outputs, conducts an analog circuit operation on the first and second digital control unit activation outputs and the stored memory value and provides an analog circuit output. A digital circuit receives the first and second digital control unit activation outputs, conducts a digital circuit operation on the first and second digital control unit activation outputs and the stored memory value to provide a digital circuit output.

The processing device can be, for instance, a computer, personal computer (PC), server or mainframe computer, or more generally a computing device, processor, application specific integrated circuits (ASIC), or controller. The processing device can be provided with, or be in communication with, one or more of a wide variety of components or subsystems including, for example, a co-processor, register, data processing devices and subsystems, wired or wireless communication links, user-actuated (e.g., voice or touch actuated) input devices (such as touch screen, keyboard, mouse) for user control or input, monitors for displaying information to the user, and/or storage device(s) such as memory, RAM, ROM, DVD, CD-ROM, analog or digital memory, flash drive, database, computer-readable media, floppy drives/disks, and/or hard drive/disks.

All or parts of the system, processes, and/or data utilized in the system of the disclosure can be stored on or read from the storage device(s). The storage device(s) can have stored thereon machine executable instructions for performing the processes of the disclosure. The processing device can execute software that can be stored on the storage device. Unless indicated otherwise, the process is preferably implemented automatically by the processor substantially in real time without delay.

The description and drawings of the present disclosure provided in the paper should be considered as illustrative only of the principles of the disclosure. The disclosure may be configured in a variety of ways and is not intended to be limited by the preferred embodiment. Numerous applications of the disclosure will readily occur to those skilled in the art. Therefore, it is not desired to limit the disclosure to the specific examples disclosed or the exact construction and operation shown and described. Rather, all suitable modifications and equivalents may be resorted to, falling within the scope of the disclosure.

1. An analog/digital hybrid architecture to accelerate Deep Neural Network (DNN) operations, said architecture comprising:
a control unit (CTRL) configured to provide a control unit weight output (HWL), a first digital control unit activation output (X_{M-A,0[i]}), and a second digital control unit activation output (XB_{M-A,0[i]});
a random-access memory device (RAM) configured to receive the control unit weight output (HWL), retrieve a stored memory value in response to a memory weight input, and provide the retrieved stored memory value as a memory device output;
an analog circuit configured to receive the first and second digital control unit activation outputs, and conduct an analog circuit operation on the first and second digital control unit activation outputs and the stored memory value from the memory device output to provide an analog circuit output; and
a digital circuit configured to receive the first and second digital control unit activation outputs, and conduct a digital circuit operation on the first and second digital control unit activation outputs and the stored memory value from the memory device output to provide a digital circuit output.

2. The architecture of claim 1, wherein the analog circuit operation comprises sub-multiplication (sub-MUL) and the digital circuit operation comprises sub-addition (sub-ADD).

3. The architecture of claim 1, wherein the sub-ADD operation comprises AND and OR operations.

4. The architecture of claim 1, wherein the analog circuit has higher energy efficiency than the digital circuit.

5. The architecture of claim 1, wherein the digital circuit has higher accuracy than the analog circuit.

6. The architecture of claim 1, further comprising an analog to digital converter (ADC) configured to convert the analog circuit output to a digital signal output, and an accumulation circuit (PM) configured to combine the digital signal output and the digital circuit output to provide a computed value.

7. The architecture of claim 1, wherein said architecture comprises a neural network.

8. The architecture of claim 1, further comprising training the architecture to update the memory weight input, whereby the memory weight input is dynamic.

9. The architecture of claim 1, wherein the memory weight input is static.

10. The architecture of claim 1, wherein the memory weight input is a weight of neural network layers that store in a memory cell a stationary value during a computation.

11. The architecture of claim 1, further comprising said control unit.

12. The architecture of claim 1, wherein the control unit analog and digital inputs are integer-based.

13. The architecture of claim 1, wherein the control unit analog and digital inputs are floating-point-based.

14. The architecture of claim 1, wherein the analog operation and/or the digital operation is an approximation.

15. The architecture of claim 1, wherein said architecture is precision-scalable.

16. The architecture of claim 1, wherein said architecture improves power efficiency.
